(19) United States
(12) Patent Application Publication
(10) Pub. No.: US 2022/0207384 A1
(43) Pub. Date: Jun. 30, 2022

(54) Extracting Facts from Unstructured Text

(71) Applicant: International Business Machines Corporation, Armonk, NY (US)

(72) Inventors: Radu Florian, Danbury, CT (US); Salim Roukos, Redondo Beach, CA (US); Martin Franz, Yorktown Heights, NY (US)

(73) Assignee: International Business Machines Corporation, Armonk, NY (US)

(21) Appl. No.: 17/137,584

(22) Filed: Dec. 30, 2020

(51) Int. Cl. G06N 5/02; G06N 20/00; G06F 40/169; G06F 40/279; G06F 40/58

(52) U.S. Cl. CPC G06N 5/025; G06N 20/00; G06F 40/58; G06F 40/279; G06F 40/169

(57) ABSTRACT

A system, computer program product, and method are provided for extraction of factual data from unstructured natural language (NL) text. A detection model is applied to convert unstructured NL text in a first language to annotated NL text. The detection model identifies two or more mentions from the unstructured NL text and a logical position of the mentions. The detection model further identifies a sequential position for each of the mentions and attaches a sequential position identifier. A pattern of rules corresponding with the annotated NL text is identified and applied to the annotated NL text, and one or more facts embedded within the annotated NL text are extracted and converted into structured data.

### BACKGROUND

The present embodiment(s) relate to a computer system, computer program product, and a computer-implemented method using artificial intelligence (AI) for extracting factual data from unstructured natural language (NL) text. Data is commonly characterized as qualitative data and quantitative data. It is understood in the art that qualitative data is descriptive information about characteristics that are difficult to define or measure, or cannot be expressed numerically, and quantitative data is directed at information in the form of counts or numbers, where a corresponding data set has one or more associated numerical values. The embodiments shown and described herein are directed at a cascaded system to automatically annotate unstructured NL, and extract qualitative and quantitative data therein together with a corresponding alignment.

### SUMMARY

The embodiments disclosed herein include a computer system, computer program product, and computer-implemented method for automatically annotating unstructured natural language, and extracting qualitative and quantitative data therein together with a corresponding alignment. This Summary is provided to introduce a selection of representative embodiments in a simplified form. Those embodiments are further described below in the Detailed Description. This Summary is neither intended to identify key features or essential features or concepts of the claimed subject matter nor to be used in any way that would limit the scope of the claimed subject matter.

In one aspect, a computer system is provided with a processing unit operatively coupled to a memory, and an artificial intelligence (AI) platform operatively coupled to the processing unit and memory. The AI platform is configured with tools in the form of a machine learning manager and a data manger configured with functionality to support extraction of factual data from unstructured natural language (NL) text. The machine learning manager is configured to apply a detection model to convert unstructured NL text in a first language to annotated NL text. The detection model identifies two or more mentions from the unstructured NL text and a logical position of the identified mentions, and attaches a label to each identified mention. The detection model further identifies a sequential position for each of the mentions and attaches a sequential position identifier to each mention. The machine learning manager applies a second model to the annotated NL text. The second model identifies a pattern of rules for the annotated NL text based on the identified logical and sequential position identifiers, and applies the pattern to the annotated NL text. Responsive to the identified pattern, the second model extracts one or more facts embedded within the identified mentions from the annotated NL text. The data manager, which is operatively coupled to the machine learning manager, functions to convert the extracted facts into structured data.

In another aspect, a computer program product is provided to support extraction of factual data from unstructured natural language (NL) text. The computer program product is provided with a computer readable storage medium having embodied program code. The program code is executable by the processing unit with functionality to apply a detection model to convert unstructured NL text in a first language to annotated NL text. The detection model identifies two or more mentions from the unstructured NL text and a logical position of the identified mentions, and attaches a label to each identified mention. The detection model further identifies a sequential position for each of the mentions and attaches a sequential position identifier to each mention. The program code supports functionality to apply a second model to the annotated NL text. The second model identifies a pattern of rules for the annotated NL text based on the identified logical and sequential position identifiers, and applies the pattern to the annotated NL text. Responsive to the identified pattern, the second model extracts one or more facts embedded within the identified mentions from the annotated NL text. Program code is further provided and executable to convert the extracted facts into generated structured data.

In yet another aspect, a method is provided for supporting extraction of factual data from unstructured natural language (NL) text. A first machine learning (ML) model is applied to convert unstructured NL text in a first language to annotated NL text. The first ML model identifies two or more mentions from the unstructured NL text and a logical position of the identified mentions, and attaches a label to each identified mention which describes a mention type. The first ML model further identifies a sequential position for each of the mentions and attaches a sequential position identifier to each mention. A second ML model is applied to the annotated NL text. The second ML model identifies a pattern of rules for the annotated NL text based on the identified logical and sequential position identifiers, and applies the pattern to the annotated NL text. Responsive to the identified pattern, the second ML model extracts one or more facts embedded within the identified mentions from the annotated NL text. The extracted facts are converted into structured data.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments, unless otherwise explicitly indicated.

FIG. 1 depicts a system diagram illustrating a schematic diagram of a computer system and embedded tools to support fact extraction from unstructured natural language data.

FIG. 2 depicts a block diagram a block diagram is provided illustrating the tools shown in FIG. 1 and their associated APIs.

FIG. 3 depicts a flow chart to illustrate a process for converting unstructured natural language text in a first language to annotated natural language text in the first language.

FIG. 4 depicts a flow chart to illustrate application of a fact aggregator to the annotated natural language text.

FIG. 5 depicts a flow chart to illustrate a process for training a new detection model to annotate natural language text in a second language.

FIG. 6 depicts a flow chart to illustrate a process for defining a set of meta-rules for application to the annotated natural language text to facilitate generalization of an initial set of rules to cover an expanded set of mention patterns.

FIG. 7 is a block diagram depicting an example of a computer system/server of a cloud based support system, to implement the system and processes described above with respect to FIGS. 1-6.

FIG. 8 depicts a block diagram illustrating a cloud computer environment.

FIG. 9 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiments. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Artificial Intelligence (AI) relates to the field of computer science directed at computers and computer behavior as related to humans. AI refers to the intelligence when machines, based on information, are able to make decisions, which maximizes the chance of success in a given topic. More specifically, AI is able to learn from a data set to solve problems and provide relevant recommendations. For example, in the field of artificial intelligent computer systems, natural language (NL) systems (such as the IBM Watson® artificially intelligent computer system or other natural language interrogatory answering systems) process NL based on system acquired knowledge.

In the field of AI computer systems, natural language processing (NLP) systems process natural language based on acquired knowledge. NLP is a field of AI that functions as a translation platform between computer and human languages. More specifically, NLP enables computers to analyze and understand human language. Natural Language Understanding (NLU) is a category of NLP that is directed at parsing and translating input according to natural language principles. Examples of such NLP systems are the IBM Watson® artificial intelligent computer system and other natural language question answering systems.

Machine learning (ML), which is a subset of AI, utilizes algorithms to learn from data and create foresights based on the data. ML is the application of AI through creation of models, for example, artificial neural networks that can demonstrate learning behavior by performing tasks that are not explicitly programmed. There are different types of ML including learning problems, such as supervised, unsupervised, and reinforcement learning, hybrid learning problems, such as semi-supervised, self-supervised, and multi-instance learning, statistical inference, such as inductive, deductive, and transductive learning, and learning techniques, such as multi-task, active, online, transfer, and ensemble learning.

At the core of AI and associated reasoning lies the concept of similarity. Structures, including static structures and dynamic structures, dictate a determined output or action for a given determinate input. More specifically, the determined output or action is based on an express or inherent relationship within the structure. This arrangement may be satisfactory for select circumstances and conditions. However, it is understood that dynamic structures are inherently subject to change, and the output or action may be subject to change accordingly. Existing solutions for efficiently identifying objects and understanding NL and processing content response to the identification and understanding as well as changes to the structures are extremely difficult at a practical level.

Artificial neural networks (ANNs) are models of the way the nervous system operates. Basic units are referred to as neurons, which are typically organized into layers. The ANN works by simulating a large number of interconnected processing units that resemble abstract versions of neurons. There are typically three parts in an ANN, including an input layer, with units representing input fields, one or more hidden layers, and an output layer, with a unit or units representing target field(s). The units are connected with varying connection strengths or weights. Input data is presented to the first layer, and values are propagated from each neuron to some neurons in the next layer. At a basic level, each layer of the neural network includes one or more operators or functions operatively coupled to output and input. The outputs of evaluating the activation functions of each neuron with provided inputs are referred to herein as activations. Complex neural networks are designed to emulate how the human brain works, so computers can be trained to support poorly defined abstractions and problems where training data is available. ANNs are often used in image recognition, speech, and computer vision applications.

Natural Language Processing (NLP) is an area of AI that bridges computer and human languages. NLP focuses on extracting meaning from unstructured data. Instances of textual references to objects or abstractions in NL text are referred to as mentions. The system, computer program product, and method shown and described herein and demonstrated in the corresponding drawings are directed at automatically extracting facts about parameters and quantities from NL text, and conversion into structured data.

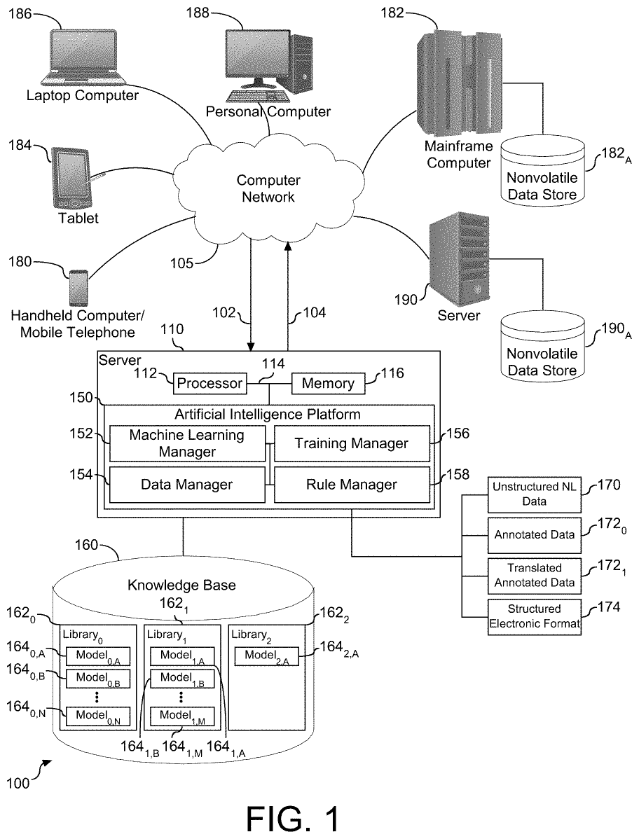

Referring to FIG. 1, a computer system (100) is provided with tools to support fact extraction from unstructured NL text. As shown, a server (110) is provided in communication with a plurality of computing devices (180), (182), (184), (186), (188), and (190) across a network connection (105). The server (110) is configured with a processing unit (112) operatively coupled to memory (114) across a bus (116). A tool in the form of an artificial intelligence (AI) platform (150) is shown local to the server (110), and operatively coupled to the processing unit (112) and memory (114). As shown, the AI platform (150) contains one or more tools in the form of a machine learning (ML) manager (152), a data manager (154), a training manager (156), and a rule manager (158). Together, the tools provide conversion of unstructured NL text into structured data, over the network (105) from one or more computing devices (180), (182), (184), (186), (188), and (190). The computing devices (180), (182), (184), (186), (188), and (190) communicate with each other and with other devices or components via one or more wires and/or wireless data communication links, where each communication link may comprise one or more of wires, routers, switches, transmitters, receivers, or the like. In this networked arrangement, the server (110) and the network connection (105) enable data conversion from an unstructured format to a structured format across distributed resources. Other embodiments of the server (110) may be used with components, systems, sub-systems, and/or devices other than those that are depicted herein.

The tools, including the AI platform (150), or in one embodiment, the tools embedded therein including the machine learning (ML) manager (152), data manager (154), training manager (156), and rule manager (158), may be configured to receive input from various sources, including but not limited to input from the network (105), and an operatively coupled knowledge base (160). As shown herein, the knowledge base (160) includes a first library (162₀) of existing ML models, shown herein by way of example as model_{0,A} (164_{0,A}), model_{0,B} (164_{0,B}), and model_{0,N} (164_{0,N}). The quantity of ML models in the first library (162₀) is for illustrative purposes and should not be considered limiting. In an embodiment, the existing ML models of the first library (162₀) are known in the art as detection models which are statistical models. A statistical model is a model for data that is used either to infer something about relationships within the data or to create a model that is able to predict future values. In ML, the statistical models are used to obtain a general understanding of data to make predictions. The knowledge base is shown herein with a second library (162₁) of existing second models, also referred to herein as fact aggregator models, shown herein by way of example as model_{1,A} (164_{1,A}), model_{1,B} (164_{1,B}), and model_{1,N} (164_{1,N}). The quantity of ML models in the second library (162₁) is for illustrative purposes and should not be considered limiting.

The various computing devices (180), (182), (184), (186), (188), and (190) in communication with the network (105) demonstrate access points for the AI platform (150) and the corresponding tools, e.g. managers, including the machine learning (ML) manager (152), data manager (154), training manager (156), and rule manager (158). Some of the computing devices may include devices for use by the AI platform (150), and in one embodiment the tools (152), (154), (156), and (158) to support extraction of facts from unstructured NL text into structured data. The network (105) may include local network connections and remote connections in various embodiments, such that the AI platform (150) and the embedded tools (152), (154), (156), and (158) may operate in environments of any size, including local and global, e.g. the Internet. Accordingly, the server (110) and the AI platform (150) serve as a front-end system, with the knowledge base (160) and one or more of the ML models (164_{0,A})-(164_{0,N}), e.g. detection models, and one or more ML models (164_{1,A})-(164_{1,M}), e.g. second models, serving as the back-end system.

As described in detail below, the server (110) and the AI platform (150) annotate NL text and extract one or more facts within an identified mention from the annotated NL text. The AI platform (150) utilizes the ML manager (152) to apply a detection model to convert unstructured NL text in a first language to annotated text in the first language. In an exemplary embodiment, the detection model is referred to as a mention detector. As shown herein, the first library (162₀) may have more than one detection model therein, with different detection models configured for different domains. In the case of multiple models in the library, the ML manager (152) identifies and selects an appropriate detection model for a corresponding domain of unstructured NL data. For example, in an embodiment, the ML manager (152) detects a language of the corresponding unstructured NL data, also referred to herein as NL text, and selects a detection model from the first library (162₀) that is trained for the detected language. Similarly, in another embodiment, the ML manager (152) detects a domain, e.g. subject matter, of the corresponding unstructured NL data, and selects a detection model from the first library (162₀) that is trained for the detected domain. An example of a domain includes, but is not limited to, subject matter, such as legal, medical, business, etc. Accordingly, as an initial aspect the ML manager (152) conducts an initial or preliminary review of the unstructured NL data to select an appropriate detection model for conversion of the unstructured NL data to annotated NL data.

Following the initial or preliminary review and selection or identification of the appropriate detection model, the NL data annotation is initiated. By way of example and for descriptive purposes, the AI platform (150) receives unstructured NL data (170) from one or more of the various computing devices (180), (182), (184), (186), (188), and (190) across with the network (105). The ML manager (152) selects detection model (164_{0,A}) directed at the received unstructured NL data (170). The selected detection model identifies two or more mentions from the unstructured NL data (170). The following is an example of unstructured NL data:
During the year ended Aug. 31, 2014, the company issues a total of 2,250,000 common shares for total proceeds of $450,000.
   The identified mentions year, data, quantity of common shares, and proceeds are shown with underlining. Each of the identified mentions is an entity type having a corresponding attribute. In an exemplary embodiment, the mention may be a phrase. Based on this example, the first identified mention, year, is a time unit, the second identified mention is a date, the third identified mention is shares, and the fourth identified mention is referred to as other.

The selected detection model attaches a label to each identified mention. The label describes a mention type and a corresponding logical position. Based on the example provided above, the label time_unit_0 is attached to the first identified mention, the label date_0 is attached to the second identified mention, the label shares_0 is attached to the third identified mention, and the label other_0 is attached to the fourth identified mention. In this example, the labels are time_unit, date, shares, and other. The numerical portion of the label is a logical position identifier and pertains to the logical position of the mention type in the NL data. The attached label is appended with a logical identifier, such as time_unit_0, with the numerical portion signifying a logical importance of the mention type in the NL data. The logical identifier is not limited to a sequential assignment. More specifically, the logical identifier is an assignment based on a logical correspondence of the mention(s) to which the identifier is attached. In an exemplary embodiment, the detection model, such as model (164_{0,A}) ascertains the logical correspondence and the logical identifier. For example, in the following natural language text:
During the 10 TIME_PERIOD_0 and 30 TIME_PERIOD_1 weeks TIME_UNIT_0 ended September 30 DATE_0, 2018 YEAR_0, the Company paid a dividend of $0.213 DIVIDEND_0 and $0.311 DIVIDEND_1 per share (2017 YEAR_1−$0.129 DIVIDEND_0 and $0.325 DIVIDEND_1 per share.
   the logical identifiers are non-sequential in their entirety. Accordingly, as shown herein, the labels Dividend_0 and Dividend_1 contain mentions that logically belong together, as reflected in the non-sequential assignment of their corresponding logical identifier.

In addition to the logical position, the detection model also identifies a sequential position of each of the identified mentions and attaches a sequential position identifier to each of the mentions. The sequential position pertains to the occurrence of the mention within the NL data across all mention types. The sequential position identifiers are assigned to each of the identified mentions based on the sequential position of the mentions in the NL unstructured data. Based on the example provided above, the detection model identified four mentions, with each mention having a different mention type. Time_unit is the first label and is modified as time_unit_0_0, with the first 0 representing the logical position of the first label and the second 0 representing the sequential position of the mention in the NL data. Similarly, date is the second label and is modified as date_0_1 with the 0 representing the logical position of the second label and the 1 representing the sequential position of the mention in the NL text, share is the third label and is modified as shares_0_2 with the 0 representing the logical position of the third label and the 2 representing the sequential position of the mention in the NL text, and other is the fourth label and is modified as other_0_3 with the 0 representing the logical position of the fourth label and the 3 representing the sequential position of the mention in the NL text. Accordingly, the detection model creates output data (172₀) in the form of annotated NL data including an attachment of both a corresponding logical identifier and a sequential position identifier to each mention.

The ML manager (152) selects a fact aggregator model from the second library (162₁), and further applies the selected fact aggregator model to the annotated NL data. The selected fact aggregator model, hereinafter referred to as the second model, leverages the output (172₀) from the detection model. More specifically, the second model identifies the logical position identifier and the sequential position identifier of each of the identified mentions presented in the output (172₀). It is understood in the art that a pattern is a sequence of items that has been created based on a rule. As shown and described herein, the pattern is directed at a sequence of mentions that has been created by a corresponding rule. Pattern matching as described herein is a conditional behavior. If the pattern is matched with the annotated data, then further output is created by the second model, as described below. Conversely, if the pattern is not matched with the annotated data, the further output is not created. At such time or in response to the identification of a pattern of rules that correspond to the annotated NL data, e.g. (172₀), the second model proceeds with application of the pattern to the annotated data. The pattern matching is based upon the logical and sequential position identifiers of the mentions in the NL data. Once the pattern is identified, the second model applies the pattern to the annotated NL data (172₀) to align the identified mentions based on the pattern. In an exemplary embodiment, the second model leverages a rule based algorithm with one or more rules that define a combination of the identified logical position and sequential position of two or more mentions. Based on the example provided above, a relevant pattern may be:
time_unit_0 date_1 shares_2
   with the numerical annotation following the label, or in one embodiment with the numerical annotation preceding the label, and with the numerical annotation directed at the order of each of the labels in the annotated NL data. For example, the pattern in this example is the NL text having the mentions presented with the time_unit preceding the date, and the date preceding the shares. Although not shown in this example, the patterns are annotated to include both the logical and sequential identifiers, as described in detail below. Accordingly, the pattern matching supports and enables the second model to further identify the mentions in the annotated NL data.

The second model proceeds to extract facts from the NL data (170). More specifically, each mention identified in the annotated data (172₀) has an embedded fact. The following is a second example of NL unstructured data:
During the 10 and 30 weeks ended Sep. 30, 2018, the Company paid a dividend of $0.213 and $0.311 per share (2017-$0.129 and $0.325 per share.)
   Output from the detection model embeds or attaches mention annotations together with logical identifiers as follows:
During the 10 TIME_PERIOD_0 and 30 TIME_PERIOD_1 weeks TIME_UNIT_0 ended September 30 DATE_0, 2018 YEAR_0, the Company paid a dividend of $0.213 DIVIDEND_0 and $0.311 DIVIDEND_1 per share (2017 YEAR_1−$0.129 DIVIDEND_0 and $0.325 DIVIDEND_1 per share.

The sentence in this example fits the following pattern showing with the logical and sequential identifiers with each mention:
TIME_PERIOD_0_0 TIME_PERIOD_1_1 TIME_UNIT_0_2 DATE_0_3 YEAR_0_4 DIVIDEND_0_5 DIVIDEND_1_6 YEAR_1_7 DIVIDEND_0_8 DIVIDEND_1_9
   The sentence pattern consists of lists of entity type, e.g. mentions, with two indexes produced by the detection model. The two indexes include the logical identifier and the sequential identifier. For each sentence pattern, there is a list of fact rules corresponding to the facts to be extracted from the sentences matching the patterns. Using the example pattern above, a corresponding set of rules is as follows:

| | | | | |
|---|---|---|---|---|
| DIVIDEND_0_5 | TIME_PERIOD_0_0 | TIME UNIT_0_2 | DATE_0_3 | YEAR_0_4 |
| DIVIDEND_1_6 | TIME_PERIOD_1_1 | TIME UNIT_0_2 | DATE_0_3 | YEAR_0_4 |
| DIVIDEND_0_8 | TIME_PERIOD_0_0 | TIME UNIT_0_2 | DATE_0_3 | YEAR_1_7 |
| DIVIDEND_1_9 | TIME_PERIOD_1_1 | TIME UNIT_0_2 | DATE_0_3 | YEAR_1_7 |

Based on the example provided and the identified and applied set of rules to the annotated data (172₀), the following facts are extracted: dividend $0.213, 10 weeks, Sep. 30, 2018, dividend $0.311, 20 weeks, Sep. 30, 2018, dividend $0.129, 10 weeks, Sep. 30, 2017, and dividend $0.325, 20 weeks, Sep. 30, 2017. As shown herein, the data manager (154) is operatively coupled to the machine learning manager (152). The data manager (154) converts the extracted facts into structured data. Based on the example provided above, the conversion of the extracted facts into structured data results in the following:

| | | | |
|---|---|---|---|
| DIVIDEND | $0.213, | 10, weeks, | Sep. 30, 2018 |
| DIVIDEND | $0.311, | 20, weeks, | Sep. 30, 2018 |
| DIVIDEND | $0.129, | 10, weeks, | Sep. 30, 2017 |
| DIVIDEND | $0.325, | 20, weeks, | Sep. 30, 2017 |

In an exemplary embodiment, the data manager (154) enters the extracted facts into an electronic format (174) with a fixed field format, such as a spreadsheet or database. Accordingly, unstructured NL data (170) is subject to processing to create annotated data (172₀), to extract facts into a structured electronic format (174).

Application of the detection model, as shown and described, is applied to unstructured NL text in a specific language, e.g. a first language. The tools and corresponding techniques for extracting facts can be applied to process data in a second language, different from the first language, without the need to annotate the NL text in the second language. As shown, the ML manager (152) is operatively coupled to the knowledge base (160) and two or more corresponding libraries, shown herein as the first library (162₀) and the second library (162₁). In an exemplary embodiment the ML manager (152) identifies a second detection model from the first library (162₀). As further shown, the training manager (156) is operatively coupled to the ML manager (152). The training manager (156) leverages a ML translation model to translate the annotated NL text (172₀) from the first language to the second language. In an exemplary embodiment, the knowledge base (160) includes a library₂, (162₂), populated with a ML translation model (164_{2,A}). Although only one model is shown in library₂, (162₂), the quantity should not be considered limiting. The ML translation model may be provided in the operatively coupled knowledge base (160), such as model (164_{2,A}), or in an exemplary embodiment communicated to the AI platform (150) across the network connection (105). For descriptive purposes, the ML translation model (164_{2,A}) is shown operatively coupled to the ML manager (152). The ML translation model (166) translates the NL annotated data (172₀) from the first language to the second language, effectively creating translated NL data (172₁). During the translation of the text, the mentions are translated from the first language to the second language, but the labels are not translated. The labels do however remain attached to the translation of the original mentions. In an exemplary embodiment, the ML manager (152) trains a new detection model on the translated annotated NL data (172₁) to produce annotated NL text in the second language. For example, it is understood that different languages have different grammar rules, which may result in changing the order of words in order to maintain the intent of the original language. The training of the new detection model on the translated annotated NL data (172₁) observes differences corresponding to changes in the order and position of words, and in an exemplary embodiment writes a rule to swap the order of the words together with any attached label(s). At the same time, with respect to the sequential position identifier, the rules are adjusted to incorporate any sequence changes. In an exemplary amendment, a unified detection model may be trained to process the data in both an original language and a separate second language. Accordingly, the new detection model addresses the differences between the first and second language while incorporating any corresponding changes to one or more of the logical and sequential identifiers.

With respect to application of the second model, e.g. the fact aggregator, the same second model as used in the first language may be applied to the translated annotated NL data (172₁). In an exemplary embodiment, the second model does not need to be re-trained on the annotated NL data in the second language. The ML manager (152) applies the second model, as provided in the second library, e.g. library₁ (162₁) of the operatively coupled knowledge base (160), to the annotated NL data in the second language, e.g. (172₁) and extracts one or more facts from the annotated NL data in the second language. With respect to the translation of the annotated NL, the text and associated mentions are subject to translation, while the labels remain in the first language, with an attachment of the labels to the translated mentions. Accordingly, the labels are language independent and transfer across the translation of the annotated NL data.

As shown and described, the second model applies rules or a rules based algorithm to align the identified mentions based on a pattern. In an exemplary embodiment, the pattern may be expanded with one or more meta-rules, e.g. patterns operating on patterns. As shown, the rule manager (158) is operatively coupled to the ML manager (152) and is configured to define one or more meta-rules to facilitate generalization of an initial set of rules or an initial rule algorithm, with the generalization expanding the initial set of rules to cover a larger quantity of mention patterns. More specifically, the meta-rule(s) extend an existing or identified pattern to include one or more additional mentions, and application of the meta-rule(s) to generate a new pattern of rules. The second model applies the new pattern of rules to the annotated NL text (172₀) and extracts one or more additional facts that correspond to the one or more additional mentions. In an exemplary embodiment, a meta-rule(s) may be applied to expand or extend a sequence of mentions. For example, a sequence of two time periods, e.g. TIME_PERIOD_0 and TIME_PERIOD_1, can be extended to cover a longer sequence of time periods, e.g. TIME_PERIOD_0, TIME_PERIOD_1, TIME_PERIOD_2, and TIME_PERIOD_3.

Accordingly, an initial set of rules may be automatically extended to extend to a larger set of mention patterns.

Although shown as being embodied in or integrated with the server (110), the AI platform (150) may be implemented in a separate computing system (e.g., 190) that is connected across the network (105) to the server (110). Similarly, although shown local to the server (110), the tools (152), (154), (156), and (158) may be collectively or individually distributed across the network (105). Wherever embodied, the ML manager (152), data manager (154), training manager (156) and rule manager (158) are utilized to extract facts, e.g. mentions, from unstructured NL text into a structured data format.

Types of information handling systems that can utilize server (110) range from small handheld devices, such as a handheld computer/mobile telephone (180) to large mainframe systems, such as a mainframe computer (182). Examples of a handheld computer (180) include personal digital assistants (PDAs), personal entertainment devices, such as MP4 players, portable televisions, and compact disc players. Other examples of information handling systems include a pen or tablet computer (184), a laptop or notebook computer (186), a personal computer system (188) and a server (190). As shown, the various information handling systems can be networked together using computer network (105). Types of computer network (105) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server (190) utilizes nonvolatile data store (190_{A}), and mainframe computer (182) utilizes nonvolatile data store (182_{A}). The nonvolatile data store (182_{A}) can be a component that is external to the various information handling systems or can be internal to one of the information handling systems.

An information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

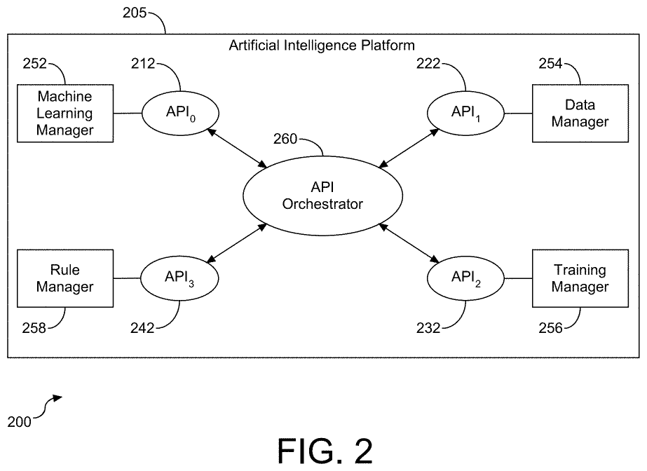

An Application Program Interface (API) is understood in the art as a software intermediary between two or more applications. With respect to the risk evaluation and modification of an executable codified infrastructure shown and described in FIG. 1, one or more APIs may be utilized to support one or more of the AI platform tools, including the ML manager (152), data manager (154), training manager (156) and rule manager (158), and their associated functionality. Referring to FIG. 2, a block diagram (200) is provided illustrating the AI platform tools and their associated APIs. As shown, a plurality of tools are embedded within the AI platform (205), with the tools including the ML manager (252) associated with API₀ (212), the data manager (254) associated with API₁ (222), the training manager (256) associated with API₂ (232), and the rule manager (258) associated with API₃ (242). Each of the APIs may be implemented in one or more languages and interface specifications.

API₀ (212) provides support for application of the detection model to convert unstructured NL text to annotated NL text, and application of the second model to the annotated NL text to extract one or more embedded facts from the NL text. API₁ (222) provides support for converting the extracted fact(s) into structured data. API₂ (232) provides support for training a second detection model to support translation of the annotated NL texts while retaining the labels with translation of the corresponding mentions. API₃ (242) provides support for defining and applying one or more meta-rules to a corresponding pattern, thereby extending the pattern to accommodate one or more additional mentions. As shown, each of the APIs (212), (222), (232), and (242) are operatively coupled to an API orchestrator (260), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

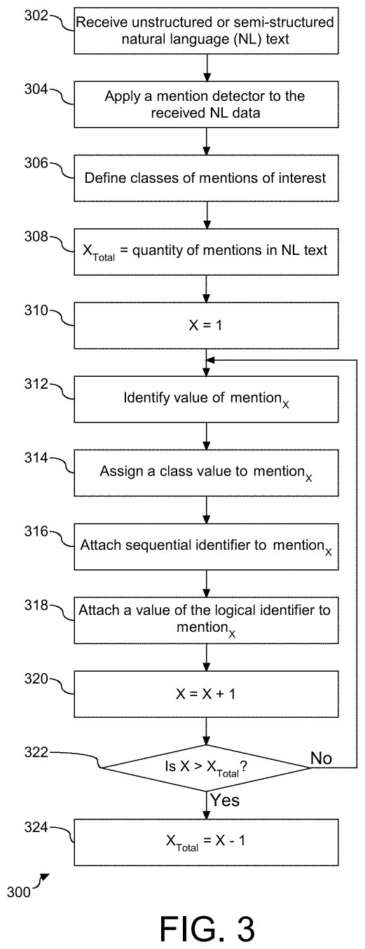

Referring to FIG. 3, a flow chart (300) is provided to illustrate a process for converting unstructured NL text in a first language to annotated NL text in the first language. Unstructured or semi-structured NL text is received (302). Semi-structured NL text is understood in the art to have some initial data therein that has been previously annotated. As shown and described herein, a detection model, also known as a mention detector is applied to the received unstructured or partially structured NL data (304), e.g. NL text. The terms NL data and NL text can be used interchangeably. Classes of mentions of interest are defined (306). As shown and described in FIG. 1, classes may be directed to different categories of numerical data, such as financial amounts, dividends, share, dates, etc. In an exemplary embodiment, the classes of categories may be pre-defined. Similarly, in an embodiment, the received NL text is subject to an initial review by the detection model to identify classes of categories present in the text. The quantity of mentions in the NL text is identified and assigned to the variable X_{Total} (308). In an exemplary embodiment, the mentions are not previously known and a mention counting variable is incremented as mentions are detected. A corresponding mention counting variable, X, is initialized (310). Each mention in the NL text is processed and annotated. As mentionₓ is identified, a corresponding attribute, e.g. value, of the mention is identified (312). A class label is assigned to the mention (314), with the label based on the identified attribute. In addition, a sequential identifier is attached to the mention (316). Accordingly, for each mention, a class label and a sequential identifier are attached to an identified mention.

As described above, the logical identifier is an assignment based on a logical correspondence of the mention(s) to which the identifier is attached. Following step (316), a value of the logical identifier is attached to the mention, e.g. mentionₓ (318). In an exemplary embodiment, the detection model, ascertains the logical correspondence and a value of the logical identifier for the attachment to the mention at step (318). Thereafter, the mention counting variable is incremented (320), followed by a determination to assess if each of the mentions in the NL text have been annotated (322). A negative response to the determination at step (322) is a return to step (312), and a positive response to the determination is followed by assigning the value of the sequential identifier counting variable, X, to X_{Total} (324) and a conclusion of the NL text annotation. Accordingly, a label, a corresponding logical identifier, and a sequential identifier are attached to each mention in the NL unstructured text, thereby created annotated NL text.

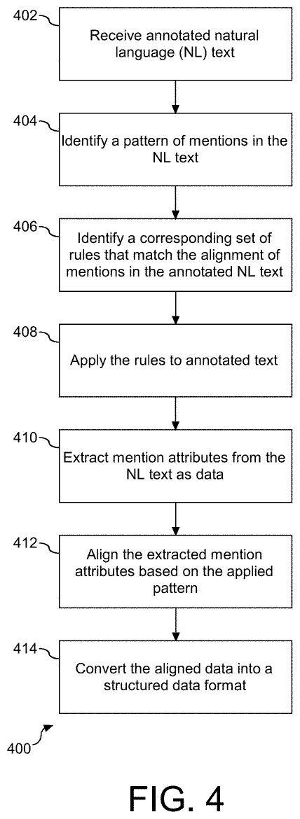

As shown and described in FIG. 3, each mention in the NL text is annotated with a label, a logical identifier corresponding to the label, and a sequential mention identifier that is non-label specific. The annotated NL text is subject to processing by a second ML model, referred to herein as a fact aggregator. Referring to FIG. 4, a flow chart (400) is provided to illustrate application of the fact aggregator to the annotated NL text. The fact aggregator, also referred to herein as the second model, leverages a rules-based algorithm for text extraction from the annotated NL text. The rules-based algorithm defines an alignment of mentions for a given patterns of labels in the annotated NL text. More specifically, the rules-based algorithm is selected based on both the logical position identifier(s) and sequential position identifier(s) of two or more mentions in the annotated NL text. Following receipt of the annotated NL text (402), the second model identifies a pattern of the mentions in the text (404). The pattern has two parts, including logical alignment of labels of mentions found in the annotation(s) and a sequence of the labels for extraction and placement. The second model identifies a corresponding set of rules or rules-based algorithm that matches or coincides with the alignment of the mentions in the annotated text (406). The second model applies the rules-based algorithm to the annotated text (408), and extracts mention attributes from the NL text as data, e.g. facts, (410). Following the data extraction, the second model aligns the extracted mention attributes based on the applied pattern (412). In an exemplary embodiment, the applied pattern may re-arrange the attributes to a different alignment than present in the NL text. The aligned data is converted into structured data or a structured data format (414). In an exemplary embodiment, the aligned data is populated into an electronic spreadsheet or database in a manner following the pattern alignment. The structured data format creates an executable assembly of the data corresponding to the mentions. Accordingly, the second model leverages rules or a rules based algorithm, and extracted data from the mentions responsive to the rules or rules algorithm, and effectively converts the extracted data into structured data.

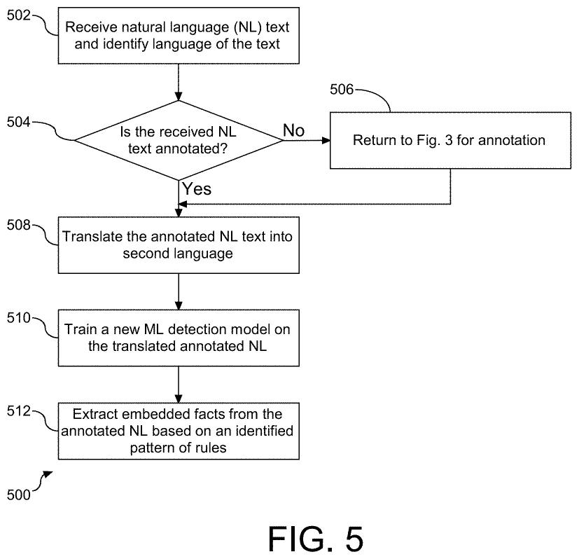

The processes shown and described in FIGS. 3 and 4 are directed to a detection model processing NL text in a given language, e.g. a first language. As it is recognized, there is a plurality of communication languages, and application of the detection model to NL text in a different language, e.g. a second language, would be beneficial for annotating translated NL text. Referring to FIG. 5, a flow chart (500) is provided to illustrate a process for training a new detection model to annotate NL text in a second language. As shown, NL text is received, and a language of the NL text is detected and identified (502). It is then determined if the received NL text is annotated (504). A negative response to the determination at step (504) is followed by a return to FIG. 3 for annotation (506). Conversely, a positive response to the determination at step (504) or following completion of the annotation, e.g. following step (506), a ML Translation Model is identified and leveraged to translate the annotated NL text into the second language, e.g. a target language, (508). The translation includes creation of the annotated NL text in the second language while retaining the labels attached to the corresponding mentions. The mentions are translated into the second language, but the labels are not subject to translation. In an exemplary embodiment, the labels function as a symbol on the matched pattern. A new ML detection model is trained on the translated annotated NL text (510), including ensuring proper attachment of the labels to the mentions. For example, in an embodiment, the order of the mentions may have been modified in accordance with grammatical rules of the second language, and the training of the new ML detection model ensures that the labels are properly aligned with the translated mentions. Accordingly, the translation of the NL text includes a translation of all components except the labels, and the training of the new detection model maintains the attachment of the labels in the first language to the mentions in the second language.

Following the translation and training of the new ML detection model, the second model, also referred to herein as the fact aggregator, is applied to the annotated NL in its translated format, e.g. the second language, (512), to extract embedded facts based on an identified pattern of rules, as shown and described in FIG. 4. In an exemplary embodiment, the second model is not subject to training or re-training for the fact extraction. Accordingly, translation of the NL text utilizes a ML translation model and a new ML detection model trained on the translated annotated NL text.

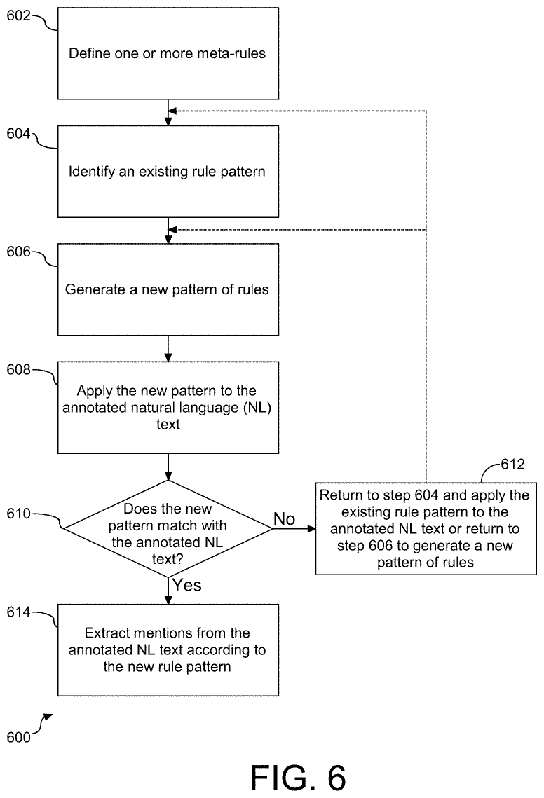

As shown and described herein, the second model leverages a pattern of rules to extracted embedded facts from the annotated NL. The pattern of rules is selected based on an identified alignment of the logical and sequential identifiers in the annotations. Referring to FIG. 6, a flow chart (600) is provided to illustrate a process for defining a set of meta-rules for application to the annotated NL text to facilitate generalization of an initial set of rules to cover an expanded set of mention patterns. Meta-rules are defined are patterns operating on patterns. One or more meta-rules are defined to expand an initial set of rules to cover a larger quantity of mention patterns (602). An existing rule pattern is identified (604). In an exemplary embodiment, the existing rule pattern was created by a subject matter expert (SME). Application of the meta-rule(s) extends an existing or identified pattern to include one or more additional mentions. The meta-rule(s) define a new pattern operating on the rule pattern of the initial rule(s), thereby generating a new pattern of rules (606). When applied to the annotated NL text (608), it is determined if the new pattern matches or aligns with the annotated NL text (610). A negative response to the determination at step (610) is followed by either returning to the existing rule pattern as identified at step (604) and application of the existing rule pattern to the annotated NL text (612), or a return to step (606) to generate a new pattern of rules. Conversely, a positive response to the determination at step (610) is followed by extracting mentions from the annotated NL text, as shown and described in FIG. 4, and according to the new rule pattern generated from application of the meta-rule(s) (614). Accordingly, as shown and described herein, the initial rule pattern may be automatically expanded through application of one or more meta-rules to generate a new rule pattern for application to the annotated NL text.

An example of application of meta-rules covers situations containing an extended sequence of mentions in the annotated NL text. For example, a pattern in a sentence may be as follows: TIME_PERIOD_1, TIME_PERIOD_2. The fact extraction rules can be automatically expanded to extend a sequence of the time. The following is an example of an extended sequence of the example pattern: TIME_PERIOD_1, TIME_PERIOD_2, TIME_PERIOD_3. Accordingly, application of the meta-rules facilitates generalization of an initial set of rules to cover a larger or extended set of mention patterns.

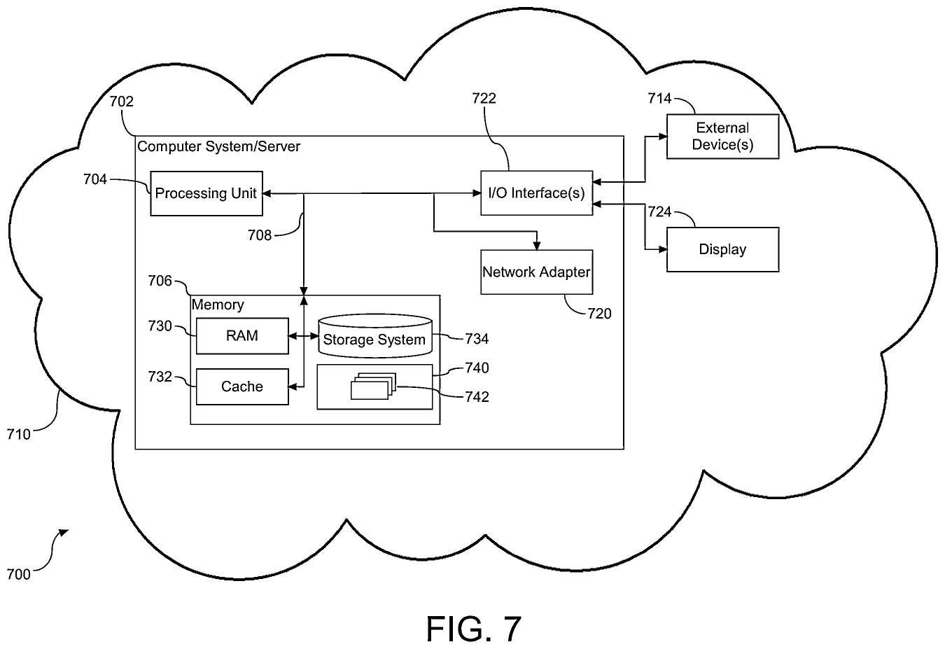

Embodiments shown and described herein may be in the form of a computer system for use with an AI platform for providing and machine learning directed at annotating unstructured NL text, extracting structured data from the annotated NL text, and converting the extracted data to structured data. Aspects of the tools (152), (154), (156), and (158) and their associated functionality may be embodied in a computer system/server in a single location, or in an embodiment, may be configured in a cloud based system sharing computing resources. With references to FIG. 7, a block diagram (700) is provided illustrating an example of a computer system/server (702), hereinafter referred to as a host (702) in communication with a cloud based support system, to implement the system and processes described above with respect to FIGS. 1-6. Host (702) is operational with numerous other general purpose or special purpose computing system environments or configurations. Examples of well-known computing systems, environments, and/or configurations that may be suitable for use with host (702) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (702) may be described in the general context of computer system-executable instructions, such as program modules, being executed by a computer system. Generally, program modules may include routines, programs, objects, components, logic, data structures, and so on that perform particular tasks or implement particular abstract data types. Host (702) may be practiced in distributed cloud computing environments (710) where tasks are performed by remote processing devices that are linked through a communications network. In a distributed cloud computing environment, program modules may be located in both local and remote computer system storage media including memory storage devices.

As shown in FIG. 7, host (702) is shown in the form of a general-purpose computing device. The components of host (702) may include, but are not limited to, one or more processors or processing units (704), a system memory (706), and a bus (708) that couples various system components including system memory (706) to processor (704). Bus (708) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (702) typically includes a variety of computer system readable media. Such media may be any available media that is accessible by host (702) and it includes both volatile and non-volatile media, removable and non-removable media.

Memory (706) can include computer system readable media in the form of volatile memory, such as random access memory (RAM) (730) and/or cache memory (732). By way of example only, storage system (734) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (708) by one or more data media interfaces.

Program/utility (740), having a set (at least one) of program modules (742), may be stored in memory (706) by way of example, and not limitation, as well as an operating system, one or more application programs, other program modules, and program data. Each of the operating systems, one or more application programs, other program modules, and program data or some combination thereof, may include an implementation of a networking environment. Program modules (742) generally carry out the functions and/or methodologies of embodiments of the adversarial training and dynamic classification model evolution. For example, the set of program modules (742) may include the modules configured as the tools (152), (154), (156), and (158) described in FIG. 1.

Host (702) may also communicate with one or more external devices (714), such as a keyboard, a pointing device, a sensory input device, a sensory output device, etc.; a display (724); one or more devices that enable a user to interact with host (702); and/or any devices (e.g., network card, modem, etc.) that enable host (702) to communicate with one or more other computing devices. Such communication can occur via Input/Output (I/O) interface(s) (722). Still yet, host (702) can communicate with one or more networks such as a local area network (LAN), a general wide area network (WAN), and/or a public network (e.g., the Internet) via network adapter (720). As depicted, network adapter (720) communicates with the other components of host (702) via bus (708). In one embodiment, a plurality of nodes of a distributed file system (not shown) is in communication with the host (702) via the I/O interface (722) or via the network adapter (720). It should be understood that although not shown, other hardware and/or software components could be used in conjunction with host (702). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (706), including RAM (730), cache (732), and storage system (734), such as a removable storage drive and a hard disk installed in a hard disk drive.

Computer programs (also called computer control logic) are stored in memory (706). Computer programs may also be received via a communication interface, such as network adapter (720). Such computer programs, when run, enable the computer system to perform the features of the present embodiments as discussed herein. In particular, the computer programs, when run, enable the processing unit (704) to perform the features of the computer system. Accordingly, such computer programs represent controllers of the computer system.

In one embodiment, host (702) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

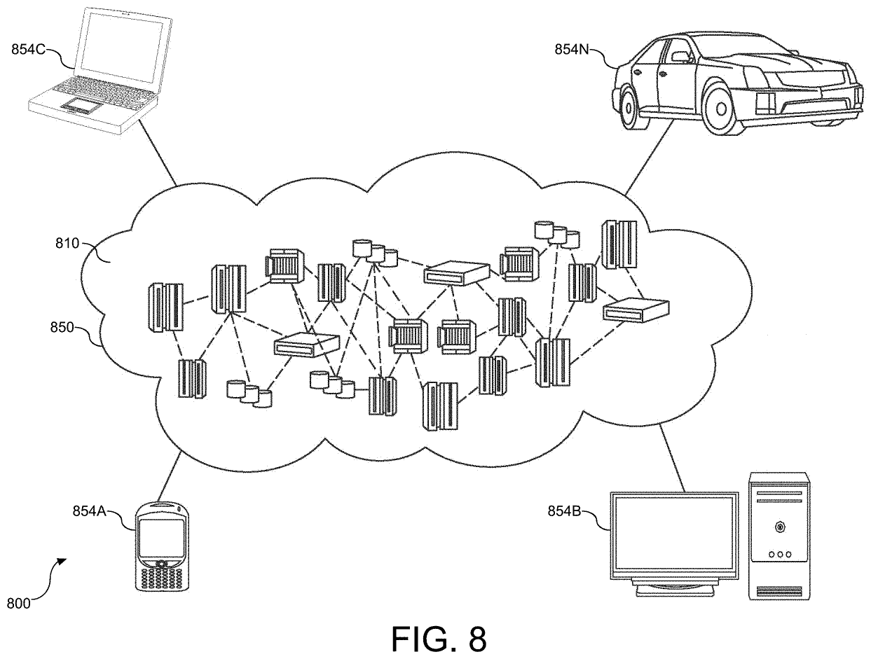

Referring now to FIG. 8, an illustrative cloud computing network (800). As shown, cloud computing network (800) includes a cloud computing environment (850) having one or more cloud computing nodes (810) with which local computing devices used by cloud consumers may communicate. Examples of these local computing devices include, but are not limited to, personal digital assistant (PDA) or cellular telephone (854A), desktop computer (854B), laptop computer (854C), and/or automobile computer system (854N). Individual nodes within nodes (810) may further communicate with one another. They may be grouped (not shown) physically or virtually, in one or more networks, such as Private, Community, Public, or Hybrid clouds as described hereinabove, or a combination thereof. This allows cloud computing environment (800) to offer infrastructure, platforms and/or software as services for which a cloud consumer does not need to maintain resources on a local computing device. It is understood that the types of computing devices (854A-N) shown in FIG. 8 are intended to be illustrative only and that the cloud computing environment (850) can communicate with any type of computerized device over any type of network and/or network addressable connection (e.g., using a web browser).

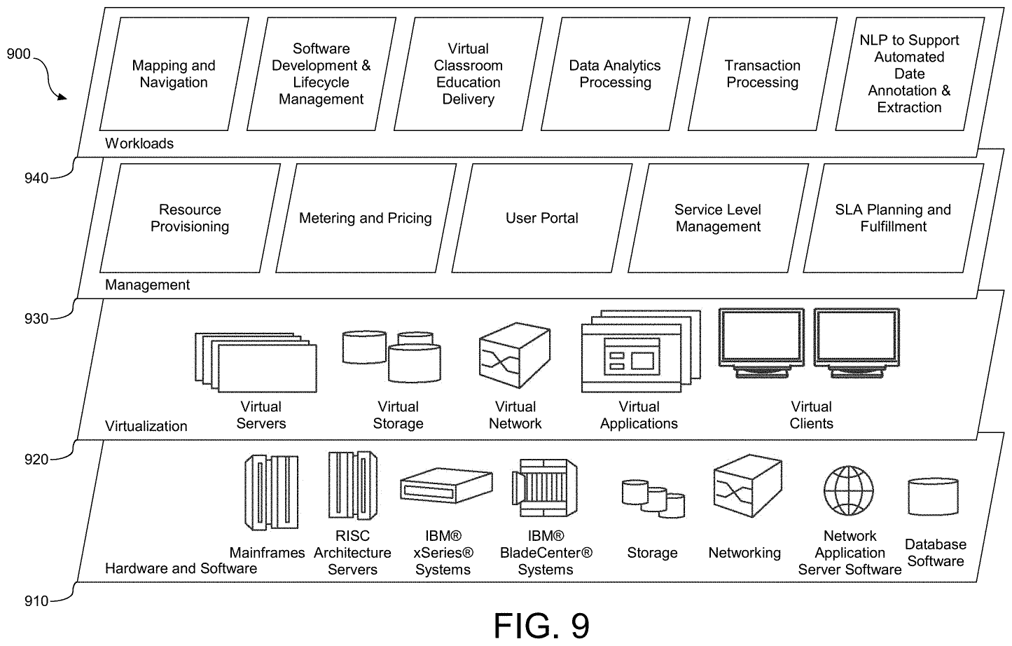

Referring now to FIG. 9, a set of functional abstraction layers (900) provided by the cloud computing network of FIG. 8 is shown. It should be understood in advance that the components, layers, and functions shown in FIG. 9 are intended to be illustrative only, and the embodiments are not limited thereto. As depicted, the following layers and corresponding functions are provided: hardware and software layer (910), virtualization layer (920), management layer (930), and workload layer (940). The hardware and software layer (910) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (920) provides an abstraction layer from which the following examples of virtual entities may be provided: virtual servers; virtual storage; virtual networks, including virtual private networks; virtual applications and operating systems; and virtual clients.

In one example, management layer (930) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (940) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and NLP to support automated data annotation and extraction.

The system and flow charts shown herein may also be in the form of a computer program device for dynamically orchestrating a pre-requisite driven codified infrastructure. The device has program code embodied therewith. The program code is executable by a processing unit to support the described functionality.

While particular embodiments have been shown and described, it will be obvious to those skilled in the art that, based upon the teachings herein, changes and modifications may be made without departing from its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to the embodiments containing only one such element, even when the same claim includes the introductory phrases “one or more” or “at least one” and indefinite articles such as “a” or “an”; the same holds true for the use in the claims of definite articles.

The present embodiment(s) may be a system, a method, and/or a computer program product. In addition, selected aspects of the present embodiment(s) may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiment(s) may take the form of computer program product embodied in a computer readable storage medium (or media) having computer readable program instructions thereon for causing a processor to carry out aspects of the present embodiment(s). Thus embodied, the disclosed system, a method, and/or a computer program product are operative to improve the functionality and operation of dynamical orchestration of a pre-requisite driven codified infrastructure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiment(s) may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiment(s).

Aspects of the present embodiment(s) are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiment(s). In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiment(s). In particular, the annotation of unstructured NL data and extraction of facts into a structured format may be carried out by different computing platforms or across multiple devices. Furthermore, the libraries of models may be localized, remote, or spread across multiple systems. Accordingly, the scope of protection of the embodiment(s) is limited only by the following claims and their equivalents.

What is claimed is:

1. A computer system comprising:
a processor operatively coupled to memory;
an artificial intelligence (AI) platform, in communication with the processor, having one or more tools, the tools comprising:
a machine learning manager configured to apply a detection model to convert unstructured NL text in a first language to annotated NL text in the first language, including the detection model configured to:
identify two or more mentions from the unstructured NL text, each mention being an entity type having an attribute;
identify a logical position of the identified two or more mentions;
attach a label to each identified mention, the label describing a mention type; and
identify a sequential position of each of the two or more mentions, and attach a sequential position identifier to each of the two or more mentions;
the machine learning manager configured to apply a second model to the annotated NL text, including the second model configured to:
identify a pattern of rules for the annotated NL text based on the identified logical position and the sequential position identifier of the two or more mentions, and apply the pattern to the annotated NL text; and
extract one or more facts embedded within the identified mentions from the annotated NL text responsive to the identified pattern; and
a data manager, operatively coupled to the machine learning manager, configured to convert the extracted one or more facts into generated structured data.

2. The computer system of claim 1, wherein application of the second model to the annotated NL text further comprises the second model to align the identified mentions responsive to the pattern, including employ a rule based algorithm with one or more rules defining a combination of the identified logical position and the identified sequential position of the two or more mentions.

3. The computer system of claim 1, further comprising a training manager configured to train a second detection model to annotate NL text in a second language different from the first language, including the training manager configured to leverage a machine learning translation model to translate the annotated NL text from the first language to the second language, and retain the labels in the first language with translation of the identified mentions.

4. The computer system of claim 3, further comprising the machine learning manager configured to apply the second model to the annotated NL text in the second language and extract one or more facts from the annotated NL text in the second language.

5. The computer system of claim 1, further comprising a rule manager configured to define one or more meta-rules for application to the identified pattern of rules for the annotated NL text in the first language, the meta-rule to extend the identified pattern to including one or more additional mentions, and generate a new pattern of rules with the one or more additional mentions.

6. The computer system of claim 5, further comprising the second model configured to apply the new pattern of rules to the annotated NL text and extract one or more additional facts corresponding to the one or more additional mentions.

7. A computer program product comprising a computer readable storage medium having program code embedded therewith, the program code executable by a processor to:
apply a detection model to convert unstructured NL text in a first language to annotated NL text in the first language, including:
identify two or more mentions from the unstructured NL text, each mention being an entity type having an attribute;
identify a logical position of the identified two or more mentions;
attach a label to each identified mention, the label describing a mention type; and
identify a sequential position of each of the two or more mentions, and attaching a sequential position identifier to each of the two or more mentions;
apply a second model to the annotated NL text, including:
identify a pattern of rules for the annotated NL text based on the identified logical position and the sequential position identifier of the two or more mentions, and apply the pattern to the annotated NL text; and
extract one or more facts embedded within the identified mentions from the annotated NL text responsive to the identified pattern; and
generate structured data, including conversion of the extracted one or more facts from the second model.

8. The computer program product of claim 7, wherein the program code to apply the second model to the annotated NL text further comprises program code to align the identified mentions responsive to the pattern, including employ a rule based algorithm with one or more rules defining a combination of the identified logical position and the identified sequential position of the two or more mentions.

9. The computer program product of claim 7, further comprising program code configured to train a second detection model to annotate NL text in a second language different from the first language, the training including leveraging a machine learning translation model to translate the annotated NL text from the first language to the second language, and retaining the labels in the first language with translation of the identified mentions.

10. The computer program product of claim 9, further comprising program code configured to apply the second model to the annotated NL text in the second language and extract one or more facts from the annotated NL text in the second language.

11. The computer program product of claim 7, further comprising program code configured to define one or more meta-rules for application to the identified pattern of rules for the annotated NL text in the first language, the meta-rule extending the identified pattern to including one or more additional mentions, and the program code to generate a new pattern of rules with the one or more additional mentions.

12. The computer program product of claim 11, further comprising program code configured to apply the second model to the new pattern of rules to the annotated NL text and extract one or more additional facts corresponding to the one or more additional mentions.

13. A computer-implemented method comprising:
applying a detection model to convert unstructured NL text in a first language to annotated NL text in the first language, including:
identifying two or more mentions from the unstructured NL text, each mention being an entity type having an attribute;
identifying a logical position of the identified two or more mentions;
attaching a label to each identified mention, the label describing a mention type; and
identifying a sequential position of each of the two or more mentions, and attaching a sequential position identifier to each of the two or more mentions;
applying a second model to the annotated NL text, including:
identifying a pattern of rules for the annotated NL text based on the identified logical position and the sequential position identifier of the two or more mentions, and applying the pattern to the annotated NL text; and
extracting one or more facts embedded within the identified mentions from the annotated NL text responsive to the identified pattern; and
converting the extracted one or more facts into structured data.

14. The computer-implemented method of claim 13, wherein applying the second model to the annotated NL text further comprises aligning the identified mentions responsive to the pattern, including employing a rule based algorithm with one or more rules defining a combination of the identified logical position and the identified sequential position of the two or more mentions.

15. The computer-implemented method of claim 13, further comprising training a second detection model to annotate NL text in a second language different from the first language, the training including leveraging a machine learning translation model to translate the annotated NL text from the first language to the second language, and retaining the labels in the first language with translation of the identified mentions.

16. The computer-implemented method of claim 15, further comprising applying the second model to the annotated NL text in the second language and extracting one or more facts from the annotated NL text in the second language.

17. The computer-implemented method of claim 13, further comprising defining one or more meta-rules for application to the identified pattern of rules for the annotated NL text in the first language, the meta-rule extending the identified pattern to including one or more additional mentions, and generating a new pattern of rules with the one or more additional mentions.

18. The computer-implemented method of claim 17, further comprising the second model applying the new pattern of rules to the annotated NL text and extracting one or more additional facts corresponding to the one or more additional mentions.
